(19) United States
(12) Patent Application Publication
(10) Pub. No.: US 2016/0060953 A1
(43) Pub. Date: Mar. 3, 2016

(54) WATERPROOF DOOR STRUCTURES AND DEVICES WITH THE SAME

(71) Applicant: HON HAI PRECISION INDUSTRY CO., LTD., New Taipei (TW)

(72) Inventor: YING-JUI HUANG, New Taipei (TW)

(21) Appl. No.: 14/842,818

(22) Filed: Sep. 1, 2015

(30) Foreign Application Priority Data
Sep. 3, 2014 (TW) 103130360

(51) Int. Cl. E06B 7/16; E06B 3/36

(52) U.S. Cl. CPC E06B 7/16; E06B 3/36

(57) ABSTRACT

A waterproof door is rotatably fixed on a housing. The housing defines an opening. The waterproof door is sealed on the opening, which comprises a cap assembly and a sealed assembly mounted on the cap assembly. The cap assembly is rotatably coupled to the housing, which comprises a handle and an extruding block mounted on the handle. The handle and the extruding block are located at two sides of the cap assembly. The sealed assembly comprises a first board and a second board. The first board comprises a support and a gasket ring surrounding the support. The second board located between the extruding block and the support, which comprises a cam comprising a first ending and a second ending opposite to the first ending.

### FIELD

The subject matter herein generally relates to waterproof door structures and devices employing the waterproof door structure.

### BACKGROUND

Waterproof door structures are generally used in sealed housings containing electronic devices. The door structures include gasket located between the door structures and the housings to resist water. The number of gasket can be increased to achieve increased waterproof level.

### BRIEF DESCRIPTION OF THE DRAWINGS

Implementations of the present technology will now be described, by way of example only, with reference to the attached figures, wherein:

FIG. 1 is a perspective view of a device with a waterproof door structure.

FIG. 2 is an exploded view of the device with the waterproof door structure of FIG. 1.

FIG. 3 is an exploded view of the device with the waterproof door structure of FIG. 2 viewed from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to waterproof door structures and devices with the same.

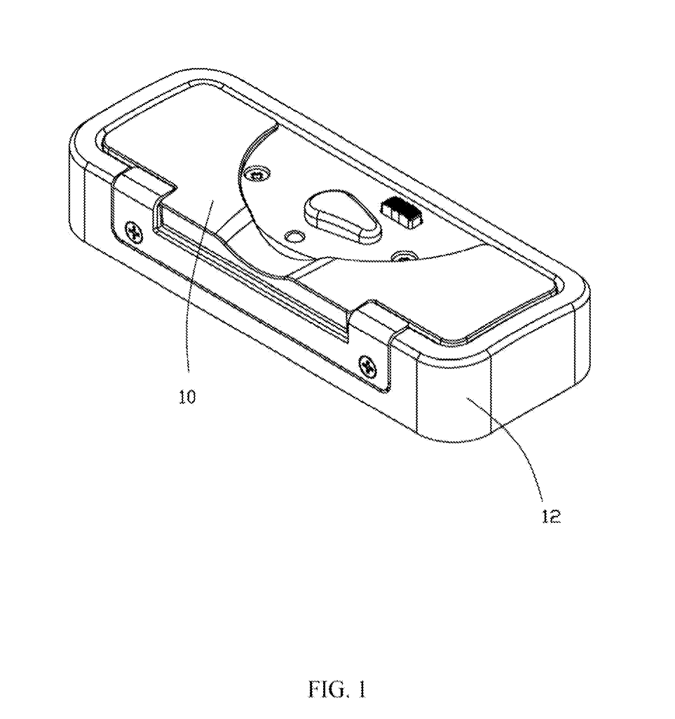

FIG. 1 illustrates that a device with a waterproof door structures 100 includes a waterproof door 10 and a housing 12. The waterproof door 10 engages with the housing 12 to seal the housing 12 and to prevent water and dust from entering into the housing 12.

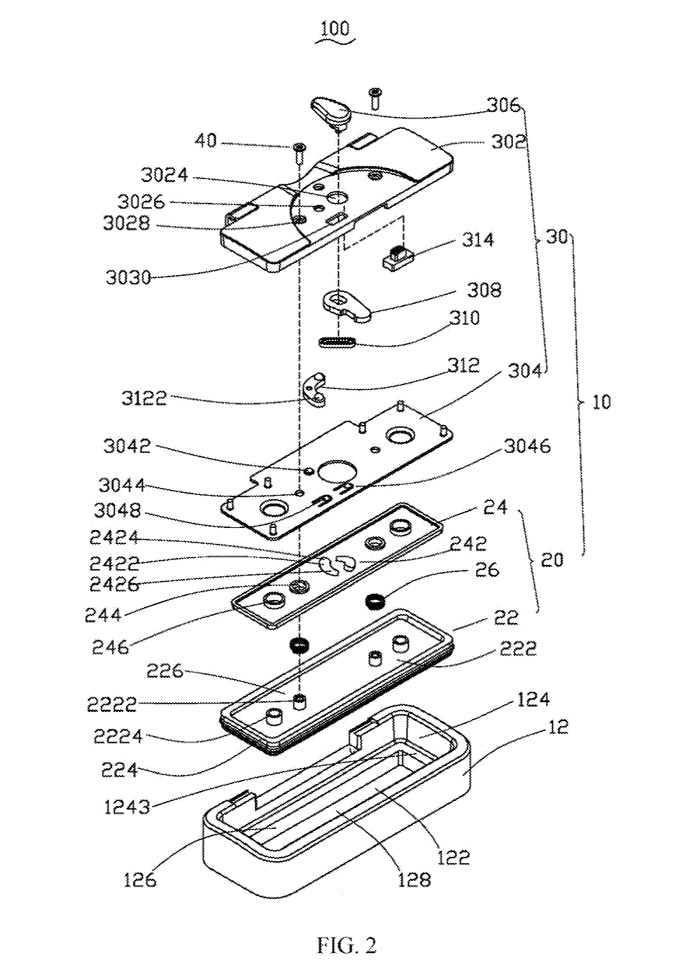

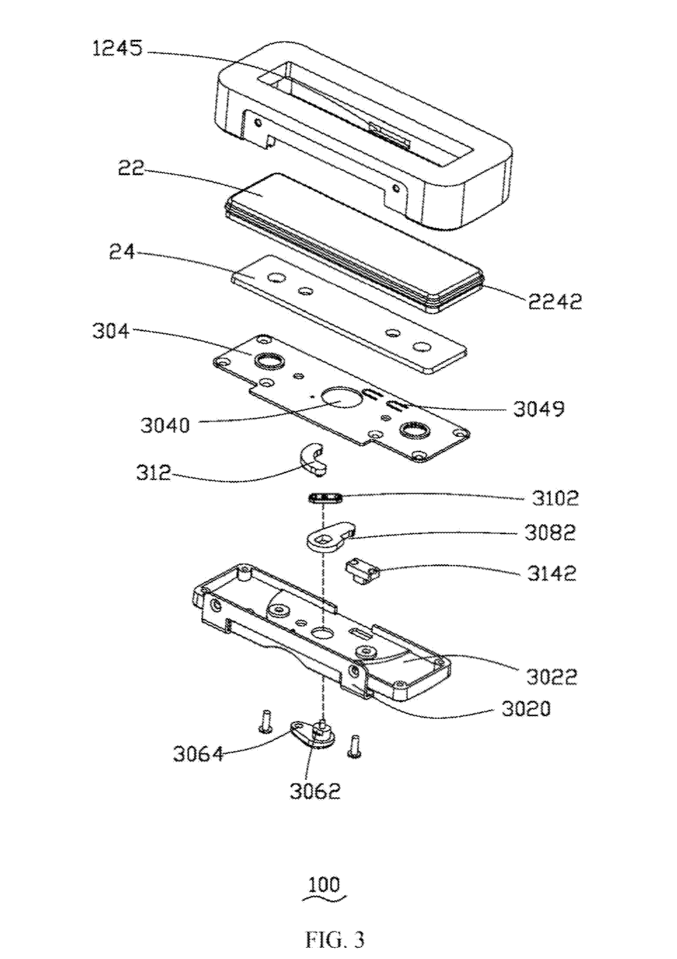

FIGS. 2-3 illustrate the housing 12 includes a bottom portion 122, and four end-to-end sidewalls 124 perpendicularly extending upwardly from the bottom portion 122. The bottom portion 122 and four sidewalls 124 define a cavity 126. The bottom portion 122 defines an opening 128. The sidewalls 124 form an inner edge 1243 to support for the waterproof door 10. Inner surface of one sidewall 124 is curved and defines a positioning slot 105.

The waterproof door 10 includes a sealed assembly 20, and a cap assembly 30. The cap assembly 30 is rotatably mounted on the housing 12, and the sealed assembly 20 is mounted on the cap assembly 30. The cap assembly 30 can cover the housing 12 or expose the housing 12. When the cap assembly 30 is covering the housing 12, the cap assembly 30 and the sealed assembly 20 are received in the cavity 126.

The sealed assembly 20 includes a first board 22, a second board 24, and a spring 26. The spring 26 is located between the first board 22 and the second board 24.

The first board 22 includes a support 222, and a gasket ring 224. The support 222 is an L shaped board, which includes a mounting post 2222, and a positioning post 2224. In the exemplary embodiment, the number of the mounting post 2222 and positioning post 2224 is two, and the mounting post 2222 and positioning post 2224 are hollow-cylindrical shapes and include internal thread. The gasket ring 224 is a hollow-rectangle frame, which surrounds the support 222 and defines a receiving space 226 with the support 222. The mounting post 2222 and positioning post 2224 are located in the receiving space 226. The gasket ring 224 extends outwardly from the support 222. In order to improve the waterproof effects, a flange 2242 protrudes from the gasket ring 224.

The second board 24 is received in the receiving space 226 and external wall of the second board 24 resists against internal wall of the gasket ring 224. The second board 24 includes a pair of symmetrical cams 242, and defines a first hole 244 and a positioning hole 246. In the exemplary embodiment, the pair of cams 242 is located at a middle position of the second board 24. The pair of cams 242 is formed in a circle. Each of the cams 242 is an arc protrusion. Top side of each cam 242 has an inclined surface 2422 to make a thickness of a first ending 2424 of the cam 242 greater than a thickness of a second ending 2426 of the cam 242. The first ending 2424 and the second ending 2426 are opposite to each other. The first ending 2424 of one cam 242 is adjacent to the second ending 2426 of the other cam 242. The number of the first holes 244 and the positioning holes is two corresponding to the mounting post 2222 and the positioning post 2224. The shapes of the first hole 244 and the positioning hole 246 are circles. The mounting post 2222 engages with the first hole 244, and the positioning post 2224 engages with the positioning hole 246 to position the second board 24 and the support 222. The spring 26 is compressed between the second board 24 and the support 222.

The cap assembly 30 includes a cover 302, a connecting board 304, a handle 306, a fixing piece 308, an extruding block 310, a positioning piece 312 and a stopper 314.

The cover 302 is an L shaped board, which is rotatably fixed on a top of the housing 12. One sidewall of the cover 302 includes a positioning board 3020 rotatably fixed on the cover 302. The positioning board 3020 is fixed on a side of the housing 12 to rotate the cover 302 with respect to the housing 12.

A surface of the cover 302 facing the housing 12 is sunken to form a receiving chamber 3022. The cover 302 includes a first mounting hole 3024, a second mounting hole 3026, a threaded hole 3028, and a third mounting hole 3030. In the exemplary embodiment, the first mounting hole 3024 is located at a middle position of the cover 302, which is a circular. The second mounting hole 3026 is adjacent to the first mounting hole 3024, in the embodiment the number of mounting holes is two and both are a circular. The number of threaded holes 3028 is two. The two threaded holes 3028 are located at the ends of the cover 302 respectfully. The third mounting hole 3030 is a rectangle shape.

The connecting board 304 is fixed on the cover 302 covering the receiving chamber 3022. The cover 302 defines a through hole 3040 corresponding to the first mounting hole 3024. A supporting portion 3042 protrudes from the connecting board 304, adjacent to the through hole 3040. The connecting board 304 defines a pair of second holes 3044 corresponding to the threaded holes 3028 and includes a pair of positioning portions 3046 corresponding to the third mounting hole 3030. Each positioning portion is resilient and has a protrusion 3048 and defines a U-shaped slot 3049 surrounding the protrusion 3048.

The handle 306 is a cam shape, one end of which is protruding to form an engaging portion 3062, the other end of which is sunken to define a first recess 3064. The engaging portion 3062 is inserted into the first mounting hole 3024 to enter the receiving chamber 3022.

The fixing piece 308, the extruding block 310, the positioning piece 312, and the stopper 314 are located in the receiving chamber 3022. The fixing piece 308 and the extruding block 310 are fixed on the engaging portion 3062 of the handle 306. The extruding block 310 is located on a side of the cover 302 away from the handle 306. The positioning piece 312 corresponds to the second mounting hole 3026. The stopper 314 corresponds to the third mounting hole 3030.

The fixing piece 308 defines a gap 3082. The extruding block 310 passes through the through hole 3040 of the connecting board 304 to resist against the cam 242 of the second board 24. A pair of balls 3012 is rotatably located on two ends of the extruding block 310. The positioning piece 312 resists against the supporting portion 3042 of the connecting board 304, which is an arc shape. A pair of elastic bulges 3122 protrudes from on two ends of the positioning piece 312. The elastic bulges 3122 are passed through the second mounting hole 3026 of the cover 302 and latched with the first recess 3064 of the handle 306 to limit the handle 306 from movement. The stopper 314 resists against the positioning portion 3046 and partially passes through the third mounting hole 3030. The stopper 314 can be moved in the third mounting hole 3030 under an external force. The stopper 314 defines a pair of second recess 3142 facing the positioning portions 3046. When the stopper 314 is pushed, the U-shaped slot 3049 forces the protrusion 3048 to be entered into or out of the second recess 3142.

In assembly, the spring 26 is sleeved on the mounting post 2222, the second board 24 is located in the receiving space 226 to resist against the spring 26. The connecting board 304 is fixed on the cover 302. A plurality of screws 40 are passed through the threaded hole 3028 and the second hole 3044 and positioned on the mounting post 2222 to fix the sealed assembly 20 on the cap assembly 30. The positioning board 3020 of the cover 302 is fixed on a side of the housing 12. The waterproof door 10 is rotatably fixed on the housing 12.

When the waterproof door 10 is latched with the housing 12, the handle 306 is rotated in a first direction under an external force to drive the fixing piece 308 and the extruding block 310 to rotate simultaneously. When one end of the fixing piece 308 is rotated to the positioning slot 1245 of the housing 12, the waterproof door 10 is fixed on the housing 12. Two ends of the extruding block 310 are slid from the second ending 2426 to the first ending 2124 of the inclined surface 2422 of the cam 242, and the second board 24 resists against the gasket ring 224 of the first board 22 and the sidewall 124 of the housing 12, which improves waterproofing. The flange 2242 of the gasket ring 224 further improves waterproofing.

When the waterproof door 10 is opened, the handle 306 is rotated in a second direction opposite to the first direction under another external force to drive the fixing piece 308 out of the positioning slot 1245 of the housing 12. The two ends of the extruding block 310 are slid from the first ending 2424 to the second ending 2426 of the inclined surface 2422 of the cam 242, and the extruding block 310 is separated from the second board 24. The extruding block 310 omits the pressure to the second board 24 detaching the gasket ring 224 from the sidewall 124 of the housing 12.

In the exemplary embodiment, the first board 22 is made by secondary molding. The first molding process uses hard material to form the support 222, and the second molding process uses flexible material to form the gasket ring 224.

In the exemplary embodiment, when the waterproof door 10 is closed or opened, the flange 2242 does not press the sidewall 124 of the housing 12, which solves the problem of interference. The handle 306 is positioned by positioning piece 312 and the elastic bulge 3122 engages with the first recess 3064 of the handle 206. The supporting portion 3042 rotates the handle 306 to be more flexible. When the fixing piece 308 is latched with the positioning slot 105, the stopper 314 engages with the gap 3082 of the fixing piece 308 to stop the fixing piece 308 from moving, which avoids operation failure of opening the waterproof door 10. The positioning portion 3046 limits the movement of the stopper 314. The balls 3102 of the extruding block 308 can reduce the friction made by the extruding block 308 to the inclined surface 2422.

In other exemplary embodiments, the second board 24 includes at least one cam 242. The cams 242 are in straight line. When the handle 306 is pushed by the external force to drive the extruding block 310 to slide on the cams 242 and the cams 242 are pressed. Correspondingly, the shape of the handle 306 and the first mounting hole 3024 is changed according to the cams 242, and the position relationship between the second mounting hole 3026 and the positioning piece 312 is changed according to the handle 306 to push the fixing piece 308 into the positioning slot 1245 of the housing 12.

The exemplary embodiments shown and described above are only examples. Many details are often found in the art such as the other features of an anti-data theft structure and electronic device with the same. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A door structure for waterproof, rotatably fixed on a housing, the housing defining an opening, the door structure for waterproof sealed on the opening, the door structure for waterproof comprising:
a cap assembly rotatably coupled to the housing, the cap assembly comprising a handle and a extruding block mounted on the handle, the handle and the extruding block located at two sides of the cap assembly; and
a sealed assembly mounted on the cap assembly, comprising:
a first board, the first board comprising a supportor and a gasket ring surrounding the supportor; and
a second board located between the extruding block and the supportor, the second board comprising a cam facing the extruding block, the cam comprising a first ending and a second ending opposite to the first ending;
wherein when the door structure for waterproof is assembled to the housing, the supportor is received in the opening, the handle is rotated in a first direction under an external force, the extruding block is slided to the first ending and the extruding block resists against the cam to seal the gasket ring to the opening of the housing;
wherein when the handle is rotated in a second direction opposite to the first direction under another external force, the extruding block releases the cam to recover the gasket ring to an original state.

2. The door structure for waterproof of claim 1, wherein a distance between the first ending and the second board is greater than a distance between the second ending and the second board.

3. The door structure for waterproof of claim 1, wherein a side of the cam facing the extruding block is an inclined surface, and the first ending is located on an end of the inclined surface away from the second board.

4. The door structure for waterproof of claim 1, wherein the housing defines a positioning slot, the cap assembly further comprises a fixing piece fixed on the handle, and when the extruding block is moved to the first ending, the fixing piece engages with the positioning slot of the housing.

5. The door structure for waterproof of claim 4, wherein the cap assembly further comprises a stopper adjacent to the fixing piece, when the fixing piece is fixed on the positioning slot, the stopper is moved to the fixing piece and resists against the fixing piece under the external force.

6. The door structure for waterproof of claim 1, wherein the cap assemble comprises a cover and a positioning piece fixed on the cover, the extruding block and the handle extrude from two opposite sides of the cover, a pair of elastic bulges protrude from two opposite ends of the positioning piece, and the elastic bulges face to a side of the positioning piece away from the handle.

7. The door structure for waterproof of claim 6, wherein the handle defines a first recess, when the extruding block moves to the first ending, one of the elastic bulges latches with the first recess, and when the extruding block moves to the second ending, the other one of the elastic bulges latches with the first recess.

8. The door structure for waterproof of claim 7, wherein the cap assembly further comprises a connecting board adjacent to the second board, the connecting board comprises a positioning portion, and the positioning portion comprises a pair of protrusions.

9. The door structure for waterproof of claim 8, wherein the stopper defines a pair of second recesses, and the positioning portions inserts into the second recesses and are detached from the second recesses under external force.

10. The door structure for waterproof of claim 1, wherein a plurality of balls protrude from the extruding block facing the second board.

11. A device with door structures for waterproof, comprising:
a housing, the housing defining an opening; and
a door structure for waterproof sealed on the opening, comprising:
a cap assembly rotatably coupled to the housing, the cap assembly comprising a handle and a extruding block mounted on the handle, the handle and the extruding block located at two sides of the cap assembly; and
a sealed assembly mounted on the cap assembly, comprising:
a first board, the first board comprising a supportor and a gasket ring surrounding the supportor; and
a second board located between the extruding block and the supportor, the second board comprising a cam facing the extruding block, the cam comprising a first ending and a second ending opposite to the first ending;
wherein when the door structure for waterproof is assembled to the housing, the supportor is received in the opening, the handle is rotated in a first direction under an external force, the extruding block is slided to the first ending and the extruding block resists against the cam to seal the gasket ring to the opening of the housing;
wherein when the handle is rotated in a second direction opposite to the first direction under another external force, the extruding block releases the cam to recover the gasket ring to an original state.

12. The device with door structures for waterproof of claim 11, wherein a distance between the first ending and the second board is greater than a distance between the second ending and the second board.

13. The device with door structures for waterproof of claim 11, wherein a side of the cam facing the extruding block is an inclined surface, and the first ending is located on an end of the inclined surface away from the second board.

14. The device with door structures for waterproof of claim 11, wherein the housing defines a positioning slot, the cap assembly further comprises a fixing piece fixed on the handle, and when the extruding block is moved to the first ending, the fixing piece engages with the positioning slot of the housing.

15. The device with door structures for waterproof of claim 14, wherein the cap assembly further comprises a stopper adjacent to the fixing piece, when the fixing piece is fixed on the positioning slot, the stopper is moved to the fixing piece and resists against the fixing piece under the external force.

16. The device with door structures for waterproof of claim 11, wherein the cap assemble comprises a cover and a positioning piece fixed on the cover, the extruding block and the handle extrude from two opposite sides of the cover, a pair of elastic bulges protrude from two opposite ends of the positioning piece, and the elastic bulges face to a side of the positioning piece away from the handle.

17. The device with door structures for waterproof of claim 16, wherein the handle defines a first recess, when the extruding block moves to the first ending, one of the elastic bulges latches with the first recess, and when the extruding block moves to the second ending, the other one of the elastic bulges latches with the first recess.

18. The device with door structures for waterproof of claim 17, wherein the cap assembly further comprises a connecting board adjacent to the second board, the connecting board comprises a positioning portion, and the positioning portion comprises a pair of protrusions.

19. The device with door structures for waterproof of claim 18, wherein the stopper defines a pair of second recesses, and the positioning portions inserts into the second recesses and are detached from the second recesses under external force.

20. The device with door structures for waterproof of claim 11, wherein a plurality of balls protrudes from the extruding block facing the second board.
